(19) United States
(12) Patent Application Publication
(10) Pub. No.: US 2026/0212361 A1
(43) Pub. Date: Jul. 23, 2026

(54) SYSTEMS AND METHODS FOR INTELLIGENT RESERVE MANAGEMENT

(71) Applicant: JPMORGAN CHASE BANK, N.A., New York, NY (US)

(72) Inventors: Sunil KUMAR, Manhattan, NY (US); Sammy LEONG, Fremont, CA (US); Kapil KAMAT, Edison, NJ (US); Lauren CHIU, San Francisco, CA (US)

(21) Appl. No.: 19/033,059

(22) Filed: Jan. 21, 2025

(51) Int. Cl. G06Q 20/40; G06Q 40/02

(52) U.S. Cl. CPC G06Q 20/4016; G06Q 40/02; G06Q 20/407

(57) ABSTRACT

Systems and methods for intelligent reserve management are disclosed. A method may include: (1) onboarding, by a marketplace operator in a marketplace, a plurality of merchants to the marketplace, wherein each merchant is provided with a virtual transaction account, wherein the merchant operator conducts transactions with customers for the merchants; (2) assessing, by the marketplace operator using a trained machine learning model, a risk associated with each merchant based on the merchant's business activity; (3) dynamically managing, by the marketplace operator, a reserve account for transactions involving the merchants based on the risk for each merchant, wherein the reserve account is used to cover negative balances or overdrafts in virtual transaction accounts of the merchants; and(4) funding, by the marketplace operator, the reserve account based on the risk.

### BACKGROUND OF THE INVENTION

### 1. Field Of The Invention Embodiments generally relate to systems and methods for intelligent reserve management.

### 2. Description of the Related Art

As customer centricity is evolving, many companies want to build relationships with customers and want to service customer's needs through a single marketplace. Consider a customer who bought an electric vehicle that is financed by a financial service. The electric vehicle manufacturer wants to provide all services to this customer, including payments for lease of the electric vehicle, insurance payments of electric vehicle, charging of electric vehicle, parking payments of electric vehicles, and servicing payments of electric vehicles. In current industry structure, however, all these services—lease issuance, insurance, charging, parking, and servicing—are provided by different companies.

In pursuit of building customer relationships and solving customer pain of dealing with multiple companies, electric vehicle manufacturers are emerging as a marketplace wherein customers buy all these services in single a place. In this marketplace, the customer is presented with a single invoice that includes fees for all services—lease issuance, insurance, charging, parking, and servicing, and the customer may make a single payment to the market operator (e.g., the electric vehicle manufacturer) may split and distribute payments to multiple service providers that provided services included in the invoice.

In order to build trust among the customers, the marketplace operator may assume the responsibility of refunds if the services are not to the satisfaction of the customers. Therefore, the marketplace operator assumes a risk when paying a seller (e.g., a service provider), as a customer may initiate a return, and/or may request a refund. In such a situation, the marketplace operator may be short of money in its account, and the account may go into overdraft and be subject to overdraft fees. The frequency of overdraft may increase based on the risk of the sellers in the marketplace. Because marketplace operate on thin margins, this cost is considered to be an inefficiency.

In addition, once the payable terms are signed for a new seller on the marketplace, it is very hard for marketplace to manage the risk of new sellers as marketplace does not know refund/return ratios of the new seller, which makes the marketplace assume unknown risk (depending on seller's performance on the marketplace).

Furthermore, in order to increase the number of sellers on a marketplace, marketplace operators often offer a favorable payable terms, such as the marketplace operator paying sellers immediately once the order is received but with a convenience fee. For example, a marketplace operator will immediately pay ($9) to parking operator immediately after a customer reserves a parking spot for $10 but deduct a convenience fee ($1) from collected funds from customers. With such payable terms, refund or returns asked by customer creates a high risk of overdraft in parking operator's merchant account as merchant accounts will immediately disburse funds to parking operator's corporate account, rending merchant accounts empty more frequently.

### SUMMARY OF THE INVENTION

Systems and methods for intelligent reserve management are disclosed. In one embodiment, a method may include: (1) onboarding, by a marketplace operator in a marketplace, a plurality of merchants to the marketplace, wherein each merchant is provided with a virtual transaction account, wherein the merchant operator conducts transactions with customers for the merchants; (2) assessing, by the marketplace operator using a trained machine learning model, a risk associated with each merchant based on the merchant's business activity; (3) dynamically managing, by the marketplace operator, a reserve account for transactions involving the merchants based on the risk for each merchant, wherein the reserve account is used to cover negative balances or overdrafts in virtual transaction accounts of the merchants; and(4) funding, by the marketplace operator, the reserve account based on the risk.

In one embodiment, the trained machine learning model is trained using historical data comprising a sales history for the plurality of merchants, refund and return rates for the plurality of merchants, chargeback rates for the plurality of merchants, product quality and reviews for goods or services offered by the plurality of merchants, inventory management for the plurality of merchants, and a financial health for the plurality of merchants.

In one embodiment, the trained machine learning model is trained using historical data comprising market conditions, a regulatory environment, a competitive landscape, seasonality, geopolitical factors, and supply chain stability.

In one embodiment, the risk for each merchant is based on an industry of the merchant, historical chargebacks/returns involving the merchant, fraudulent activity based on consumer profiles involving the merchant, an average order value for the merchant, and return patterns for the merchant.

In one embodiment, each of the plurality of merchants is associated with a reserve account for that merchant.

In one embodiment, the reserve account for each merchant is funded by the associated merchant.

In one embodiment, the virtual transaction account comprises an account that is issued by a financial institution for ledgering of customer funds.

In one embodiment, the method may also include: receiving, by the marketplace operator, payment for a good or service provided by one of the merchants from a customer; moving, by the marketplace operator, a portion of the payment to a merchant account for the merchant; receiving, by the marketplace operator, a request for a refund from the customer; refunding, by the marketplace operator, the payment to the customer from a merchant operator virtual transaction account; and moving, by the marketplace operator, funds for the payment from the merchant virtual transaction account to the merchant operator virtual transaction account.

In one embodiment, the method may also include moving, by the marketplace operator, funds from the reserve account in response to the merchant virtual transaction account having insufficient funds.

In one embodiment, the method may also include: re-assessing, by the marketplace operator, the risk; and adjusting, by the marketplace operator, the funding in response to the re-assessing.

According to another embodiment, a non-transitory computer readable storage medium may include instructions stored thereon, which when read and executed by one or more computer processors, cause the one or more computer processors to perform steps comprising: onboarding a plurality of merchants to a marketplace, wherein teach merchant is provided with a virtual transaction account, wherein a marketplace operator conducts transactions with customers for the merchants; assessing, using a trained machine learning model, a risk associated with each merchant based on the merchant's business activity; dynamically managing a reserve account for transactions involving the merchants based on the risk for each merchant, wherein the reserve account is used to cover negative balances or overdrafts in virtual transaction accounts of the merchants; and funding the reserve account based on the risk.

In one embodiment, the trained machine learning marketplace is trained using historical data comprising a sales history for the plurality of merchants, refund and return rates for the plurality of merchants, chargeback rates for the plurality of merchants, product quality and reviews for goods or services offered by the plurality of merchants, inventory management for the plurality of merchants, and a financial health for the plurality of merchants.

In one embodiment, the trained machine learning marketplace is trained using historical data comprising market conditions, a regulatory environment, a competitive landscape, seasonality, geopolitical factors, and supply chain stability.

In one embodiment, the risk for each merchant is a based an industry of the merchant, historical chargebacks/returns involving the merchant, fraudulent activity based on consumer profiles involving the merchant, an average order value for the merchant, and return patterns for the merchant.

In one embodiment, each of the plurality of merchants is associated with a reserve account for that merchant.

In one embodiment, the reserve account for each merchant is funded by the associated merchant.

In one embodiment, the virtual transaction account comprises an account that is issued by a financial institution for ledgering of customer funds.

In one embodiment, the non-transitory computer readable storage medium may also include instructions stored thereon, which when read and executed by the one or more computer processors, cause the one or more computer processors to perform steps comprising: receiving payment for a good or service provided by one of the merchants from a customer; moving a portion of the payment to a merchant account for the merchant; receiving a request for a refund from the customer; refunding the payment to the customer from a merchant operator virtual transaction account; and moving funds for the payment from the merchant virtual transaction account to the merchant operator virtual transaction account.

In one embodiment, the non-transitory computer readable storage medium may also include instructions stored thereon, which when read and executed by the one or more computer processors, cause the one or more computer processors to perform steps comprising: moving funds from the reserve account in response to the merchant virtual transaction account having insufficient funds.

In one embodiment, the non-transitory computer readable storage medium may also include instructions stored thereon, which when read and executed by the one or more computer processors, cause the one or more computer processors to perform steps comprising: re-assessing the risk; and adjusting the funding in response to the re-assessing.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for intelligent reserve management according to an embodiment.

FIG. 2 depicts a method for intelligent reserve management according to an embodiment.

FIG. 3 depicts a method for intelligent reserve management is disclosed according to an embodiment.

FIG. 4 depicts an exemplary computing system for implementing aspects of the present disclosure.

### DETAILED DESCRIPTION OF PREFERRED EMBODIMENTS

Embodiments are directed to systems and methods for intelligent reserve management.

Embodiments may provide a reserve management component and a balance management component to a marketplace. For example, the reserve management component may keep a reserve account that may be funded by a marketplace operator and may be used when any of the seller accounts go into a negative balance (e.g., overdraft). An example of a suitable account is a virtual transaction account (VTA) which can be a FDIC insured bank account, an account that is issued by a bank for various embedded finance or payment applications and services, mostly used for ledgering of customer funds.

The marketplace operator may dynamically manage the balances in the reserve account based on sales activity in the marketplace (e.g., high sales activity may increase the possibility of return, and may lead to a higher reserve account balance). The balance management component ensures that any overdraft funded from the reserve account is clawed back from the merchant's accounts as soon as the merchant's account balance reaches a level equivalent to the loaned amount. This dynamic management helps maintain financial equilibrium and reduces the risk of prolonged negative balances.

The balance management component may keep a ledger system for ensuring that the seller overdraft is funded from the reserve account, and that those funds are clawed back from the seller's accounts when the seller's account reaches a level equivalent to a loaned amount from reserve management, resulting from continuous orders received after loaned position. The balance management component may trigger alerts for depletion of reserve management and refilling the reserve from marketplace operator's external demand deposit account.

Embodiments may provide automated mechanisms for assessing the risk associated with each merchant based on their business activity and historical data. It triggers alerts for the depletion of reserve funds and the need for refilling the reserve account, ensuring proactive financial management.

Embodiments may handle various refund and return scenarios, including full refunds, partial refunds, ACH returns, and payout reversals. This comprehensive approach ensures that the marketplace can efficiently manage customer dissatisfaction and financial discrepancies.

Embodiments provide flexible merchant onboarding and classification using automated Know Your Customer (KYC) and Know Your Business (KYB) checks and classification based on risk levels. This flexibility ensures that the marketplace can adapt to new sellers and manage their associated risks effectively.

Embodiments may provide real-time management of funds, including the movement of funds between customer accounts, marketplace operator accounts, and merchant accounts. This real-time capability ensures that financial transactions are processed efficiently and accurately.

By assuming the responsibility for refunds and returns, the marketplace operator can build trust with customers, ensuring a better customer experience and fostering long-term relationships.

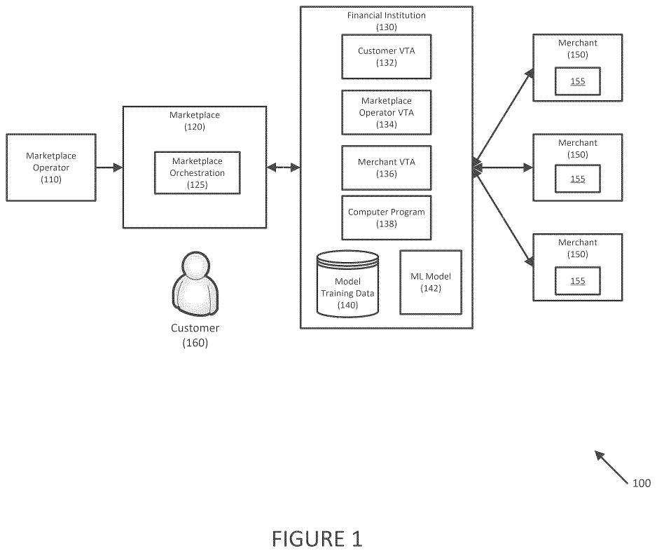

Referring to FIG. 1, a system for intelligent reserve management is disclosed according to an embodiment. System 100 may include marketplace operator 110; marketplace 120 which may include marketplace orchestration 125; financial institution 130; and merchants 150. Customer 160 may be a customer of marketplace operator 110, which may coordinate the delivery and billing for goods or services provided by marketplace operator 110 and merchants 150.

Financial institution 130 may maintain accounts, such as customer VTA 132, marketplace operator VTA 134, and merchant VTAs 136 (i.e., one merchant VTA 136 for each merchant 150), etc. Financial institution 130 may also execute computer program 138 that may predict an amount of reserve funds for one or more of merchants 150. Computer program 138 may train machine learning (ML) model 142 using model training data 140. Training data 140 may include data from data sources such as internal data sources, external data sources, and historical data.

Examples of training data from internal data sources may include, for each seller, the sales history (e.g., the volume of sales over time, consistency and growth trends in sales, etc.), refund and return rates (e.g., frequency and reasons for refunds or returns, comparison with industry averages, etc.); chargeback rates (e.g., frequency of chargebacks and disputes, reasons for chargebacks, etc.); account age (e.g., how long the seller has been active on the platform, etc.); compliance with platform policies (e.g., history of policy violations or warnings, adherence to terms of service, etc.); product quality and reviews (e.g., average product ratings and customer reviews, frequency of negative feedback, etc.); inventory management (e.g., ability to fulfill orders on time, stock levels and management practices, etc.); financial health (e.g., creditworthiness and financial stability, payment history and outstanding debts); etc. Examples of training data from external data sources may include Market Conditions (e.g., economic trends that might affect consumer spending, Industry-specific challenges or opportunities, etc.); regulatory Environment (e.g., Changes in laws or regulations affecting the seller's business, compliance with local and international trade laws, etc.);

Competitive Landscape (e.g., the Number and strength of competitors, Market share and positioning, etc.); seasonality (e.g., impact of seasonal trends on sales and returns, Historical performance during peak and off-peak seasons, etc.); geopolitical Factors (e.g., the Political stability in the seller's operating regions, Trade restrictions or tariffs, etc.); supply Chain Stability (e.g., Reliability of suppliers and logistics partners, Vulnerability to disruptions, etc.); etc.

Machine learning model 142 may be trained with the model training data 140, and may be updated with feedback as it is received.

Financial institution 130 may include banks, payment service providers, FinTechs, etc.

In one embodiment, marketplace operator 110 may provide a good or service that merchants 150 may support. For example, marketplace operator 110 may be a manufacturer of electric vehicles, and merchants 150 may provide goods or services for that electric vehicle, such as insurance, maintenance, parking, tolls, etc. Customer 160 may establish a relationship with marketplace operator 110 such that customer 160 is billed, via marketplace operator 110, for goods or services provided by merchants 150. Marketplace orchestrator 125 may facilitate establishing the relationships with customer 160 to do so.

Using trained machine learning model 142, computer program 138 may evaluate various criteria to predict if a particular sale has a high probability of return, and factor that into the reserve calculations. Examples include certain products that may have high returns due to product quality issues, certain purchasers may have a high return history, etc. The prediction forms an input to the intelligent reserve management, and may be used to determine an amount of reserve funds required for one or more merchants 150.

Marketplace operator 110 may exist in different forms. For example, marketplace operator 110 may be a provider of an e-commerce system, or it may be provided in an electronic device, such as in an application executed by an infotainment system in a vehicle that allows the driver to order and pay for vehicle services directly via the interface.

Marketplace orchestrator 125 may manage the e-commerce system, such as a website, where merchants 150 may be provided with tools to merchandise their product or services to end customers. Marketplace orchestrator 125 may manage all orders received from various customers and route those orders to appropriate merchants 150 and presents the merchant's pricing at checkout. In addition, marketplace operator 110 may facilitate payments for various product and services sold to customers.

Customer VTA 132, marketplace operator VTA 134, merchant VTAs 136, etc. may be accounts that are controlled by marketplace operator 110. These accounts may be used to transfer funds to merchant account 155 for one of merchants 150.

Marketplace operator 110 may use marketplace operator VTA 134 to ledger funds to track marketplace fees and/or commissions.

Each merchant 150 may maintain its merchant account 155, which may be a demand deposit account, a treasury account, etc. Merchant accounts 155 may be maintained with a separate financial institution (not shown).

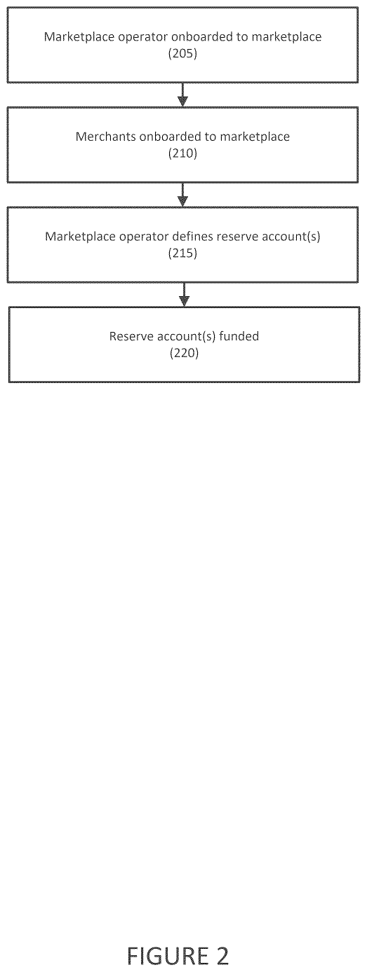

Referring to FIG. 2, a method for intelligent reserve management is disclosed according to an embodiment.

In step 205, a marketplace operator may be onboarded to a marketplace by a financial institution, a payment service provider, a FinTech, etc. For example, the financial institution may execute a computer program that performs the onboarding. The marketplace operator may be issued a merchant identifier. Payments that are received against the merchant identifier by the marketplace operator, and the marketplace operator may create relationships with various merchants (e.g., sellers).

In step 210, merchants may be onboarded to the marketplace. For example, the marketplace operator may request the financial institution, payment service provider, FinTech, etc. to onboard these merchants to the marketplace and to create virtual transaction accounts for these merchants. The merchants may also be onboarded by the computer program.

In one embodiment, the marketplace operator or the financial institution, payment service provider, FinTech, etc. may provide each merchant with a link to an online form in which the merchants may provide and upload merchant information. This allows the financial institution, payment service provider, FinTech, etc. to complete its Know Your Customer (KYC) or Know Your Business (KYB) checks necessary to create a virtual transaction account for each merchant. In one embodiment, the marketplace operator cannot instruct financial institution or payment service provider to issue a virtual transaction account until KYC or KYB is complete for a merchant, and hence cannot receive payments for that merchant.

The information may allow the marketplace operator to classify the merchants as low, medium, or high risk based on merchants'business activity. This classification may be used as a factor to define a reserve amount requirement.

Each merchant may be identified by a North American Industry Classification System (NAICS) code, and the corresponding onboarding flow may be triggered based on NAICS code of a merchant (e.g., a merchant may be classified as a “Dealership” which is a non-banking financial institution (NBFI) and onboarding questionnaire will be presented to dealership merchant based on this NAICS code). For certain merchants that want to diversify product offering (e.g., earlier selling auto insurance and now want to sell EV charging to drivers), an automated reasoning logic is used to trigger incremental KYC or KYB which requests only the required additional documents before the merchant can start selling those incremental or diversified services.

In step 215, the marketplace operator may define a reserve account to the computer program. For example, the marketplace operator may define whether the reserve account is a single account managed and funded by the marketplace operator, or if there is a reserve account for each merchant that may be funded and managed by each merchant.

In step 220, the reserve account may be funded according to the definition. For example, the marketplace operator may fund the reserve account, or the merchants may fund their individual reserve accounts. The amount of funding may be based, for example, on the risk classification of the merchant, the merchant's history, etc.

In one embodiment, a machine learning model may be used to evaluate various parameters and to predict the amount of reserve balance that a particular marketplace operator would need to maintain for all merchants, or for individual merchants. Examples of parameters that may be considered include some or all of the following: historical chargebacks/returns, fraudulent activity based on consumer profiles, customer satisfaction and reviews of product, average order value, merchant tenure, merchant reviews, volume of sales transactions, merchant compliance with regulations and policies, geographical location of product sale, geographical location of where the product will be used, history of sales by particular merchant, product category, sales/return patterns for product category, time during which a product is sold (e.g., high returns after a holiday season may need higher reserve to be maintained), etc. Additional and/or different parameters may be considered as is necessary and/or desired.

The machine learning model may be trained with any historical data that is already available as well as data that is publicly available. The machine learning model may be continuously trained to improve accuracy of the predictions.

The marketplace operator may choose to adjust/finetune the parameters for the machine learning model and the calculated reserve amount thereby making the machine learning model more specific to the marketplace operators use case. Marketplace operators may be provided with various options to fund the reserve account (e.g., direct debit from marketplace operator's account (working capital or treasury account) or their DDA, or by sending a notification that funding is required which will result in manual instruction from operator). In addition, if the machine learning model determines that the reserve has excess balance then the funds may be moved back to the operator.

Additionally, the machine learning model may predict the reserve amount for each merchant in the marketplace, thereby informing risk profiles of all merchants of the marketplace which helps marketplace operator calculate reserve amount for each merchant in the marketplace operator.

In one embodiment, the risk may be re-assessed and the reserve amount may be adjusted. For example, the risk may be re-assessed before a period of low demand or high demand, such as a holiday season, in response to market conditions, when a threshold is met (e.g., a number of returns in a period of time is met, a customer satisfaction rating is achieved, etc.). The risk may also be re-assessed periodically or as otherwise necessary and/or desired.

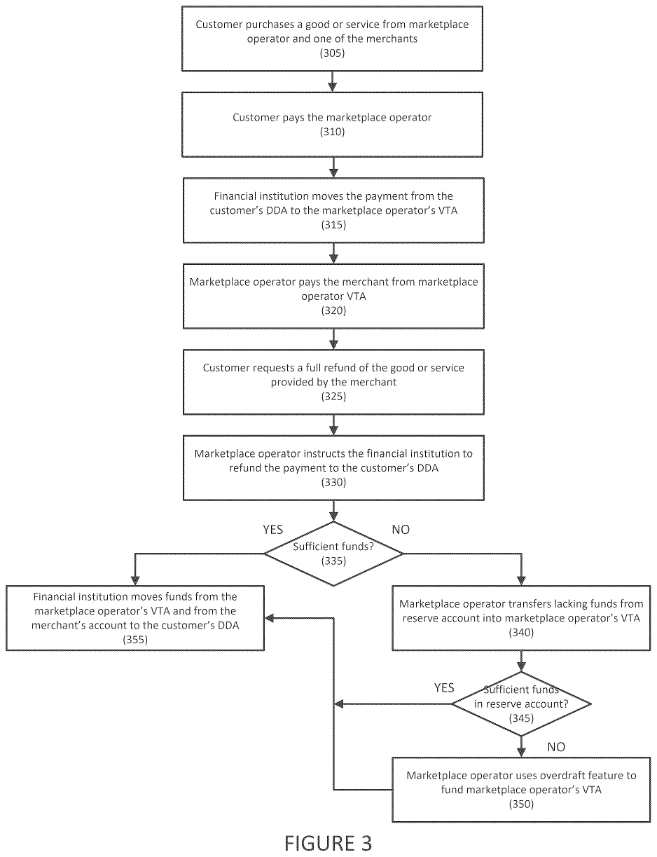

Referring to FIG. 3, a method for intelligent reserve management is disclosed according to an embodiment. In the context of a paying refund, the system initiates a series of steps to ensure the efficient and accurate processing of refunds to customers. When a customer requests a refund for a previously purchased good or service, the marketplace operator receives the refund request and verifies the transaction details. The marketplace operator then instructs the financial institution to initiate the refund process. The financial institution moves the required funds from the marketplace operator's account and the relevant merchant's virtual transaction account to the customer's demand deposit account (DDA).

To manage the financial risk associated with refunds, the system utilizes a reserve account funded by the marketplace operator. This reserve account covers any negative balances or overdrafts in the merchants'virtual transaction accounts that may arise due to refund requests. The balance management component ensures that any overdraft funded from the reserve account is clawed back from the merchant's virtual transaction account as soon as the account balance reaches a level equivalent to the loaned amount. This dynamic management helps maintain financial equilibrium and reduces the risk of prolonged negative balances.

In step 305, a customer may purchase a good or service from marketplace operator and one of the merchants. In one embodiment, the customer may optionally be provided with a customer VTA.

In step 310, the customer may pay the marketplace operator via, for example, a customer DDA.

In step 315, the financial institution may move the payment from the customer's DDA to the marketplace operator's VTA.

In step 320, the marketplace operator may pay the merchant by moving funds from the marketplace operator's VTA to the merchant's VTA. The marketplace operator may retain a certain amount of the payment for a service fee.

In step 325, the customer may request a full or partial refund of the good or service provided by the marketplace operator and the merchant.

In step 330, the marketplace operator may instruct the financial institution to refund the payment to the customer's DDA.

In one embodiment, a check may be made to validate that the refund can be applied to the customer. The merchant's VTA can go negative in the event there is insufficient funds (which will then automatically invoke the reserve account fund utilization). As new orders come in, the negative amount will be applied to the merchant's VTA balance prior to payouts. Additionally, marketplace orchestration may maintain a log of funds in and funds out of each merchant's VTA and net balances thereof.

In one embodiment, if there are insufficient funds in the marketplace operator VTA and the merchant VTA to pay for the full or partial refund, the marketplace operator may use the reserve account to provide the lacking funds.

In step 335, the marketplace operator may determine whether there are sufficient funds in the marketplace operator's VTA and/or the merchant's VTA to fund the refund to the customer. If there are, in step 355, the marketplace operator may cause the financial institution to move funds from the marketplace operator's account and from the merchant's VTA and/or the merchant's VTA to the customer's DDA.

If there are insufficient funds, in step 340, the marketplace operator may transfer funds from the marketplace operator reserve account and/or the merchant's reserve account to the marketplace operator's VTA.

In step 345, the marketplace operator may check to see if the marketplace operator's VTA has sufficient funds for the refund. If it does, in step 355, the marketplace operator may cause the financial institution to move funds from the marketplace operator's account and from the merchant's VTA and/or the merchant's VTA to the customer's DDA.

If there are insufficient funds in the marketplace operator's VTA and/or the merchant's VTA, in step 350, the marketplace operator may use an overdraft feature to fund the marketplace operator's VTA with the lacking funds.

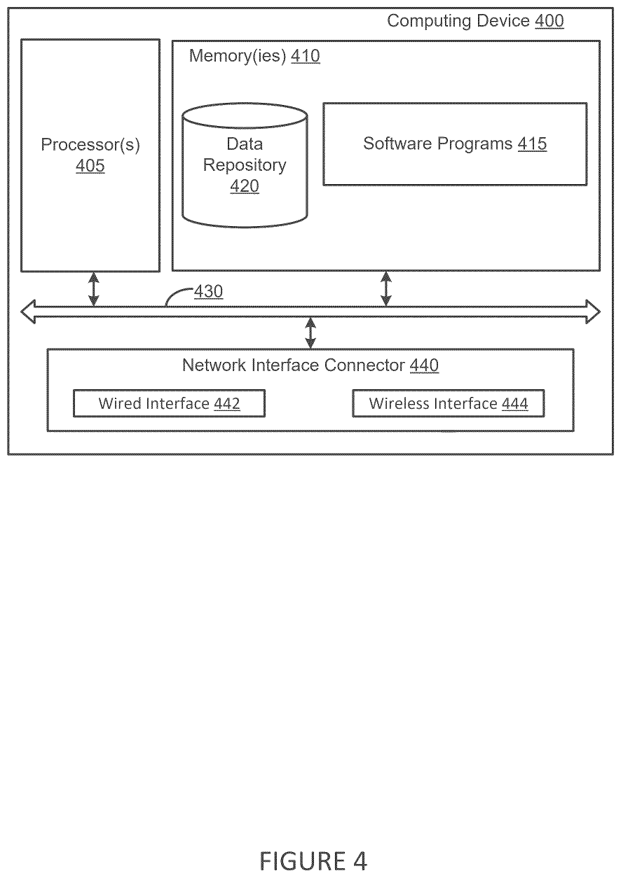

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information.

Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention.

Accordingly, the foregoing disclosure is not intended to be construed or to limit the present invention or otherwise to exclude any other such embodiments, adaptations, variations, modifications or equivalent arrangements.

1. A method, comprising:
onboarding, by a marketplace operator in a marketplace, a plurality of merchants related to a common good or service, wherein each merchant is provided with a virtual transaction account, wherein the merchant operator conducts transactions related to the common good or service with customers on behalf of the merchants and issues payments to the plurality of merchants;
assessing, by the marketplace operator using a trained machine learning model, a risk associated with each merchant based on the merchant's business activity;
dynamically managing, by the marketplace operator, a reserve account for transactions involving the merchants based on the risk for each merchant, wherein the reserve account is used to cover negative balances or overdrafts in virtual transaction accounts of the merchants; and
funding, by the marketplace operator, the reserve account based on the risk.

2. The method of claim 1, wherein the trained machine learning model is trained using historical data comprising a sales history for the plurality of merchants, refund and return rates for the plurality of merchants, chargeback rates for the plurality of merchants, product quality and reviews for goods or services offered by the plurality of merchants, inventory management for the plurality of merchants, and a financial health for the plurality of merchants.

3. The method of claim 1, wherein the trained machine learning model is trained using historical data comprising market conditions, a regulatory environment, a competitive landscape, seasonality, geopolitical factors, and supply chain stability.

4. The method of claim 1, wherein the risk for each merchant is based on an industry of the merchant, historical chargebacks/returns involving the merchant, fraudulent activity based on consumer profiles involving the merchant, an average order value for the merchant, and return patterns for the merchant.

5. The method of claim 1, wherein each of the plurality of merchants is associated with a reserve account for that merchant.

6. The method of claim 5, wherein the reserve account for each merchant is funded by the associated merchant.

7. The method of claim 1, wherein the virtual transaction account comprises an account that is issued by a financial institution for ledgering of customer funds.

8. The method of claim 1, further comprising:
receiving, by the marketplace operator, payment for a good or service provided by one of the merchants from a customer;
moving, by the marketplace operator, a portion of the payment to a merchant account for the merchant;
receiving, by the marketplace operator, a request for a refund from the refunding, by the marketplace operator, the payment to the customer from a merchant operator virtual transaction account; and
moving, by the marketplace operator, funds for the payment from the merchant virtual transaction account to the merchant operator virtual transaction account.

9. The method of claim 8, further comprising:
moving, by the marketplace operator, funds from the reserve account in response to the merchant virtual transaction account having insufficient funds.

10. The method of claim 1, further comprising:
re-assessing, by the marketplace operator, the risk; and
adjusting, by the marketplace operator, the funding in response to the re-assessing.

11. A non-transitory computer readable storage medium, including instructions stored thereon, which when read and executed by one or more computer processors, cause the one or more computer processors to perform steps comprising:
onboarding a plurality of merchants related to a common good or service, wherein each merchant is provided with a virtual transaction account, wherein a marketplace operator conducts transactions related to the common good or service with customers on behalf of the merchants and issues payments to the plurality of merchants;
assessing, using a trained machine learning model, a risk associated with each merchant based on the merchant's business activity;
dynamically managing a reserve account for transactions involving the merchants based on the risk for each merchant, wherein the reserve account is used to cover negative balances or overdrafts in virtual transaction accounts of the merchants; and
funding the reserve account based on the risk.

12. The non-transitory computer readable storage medium of claim 11, wherein the trained machine learning marketplace is trained using historical data comprising a sales history for the plurality of merchants, refund and return rates for the plurality of merchants, chargeback rates for the plurality of merchants, product quality and reviews for goods or services offered by the plurality of merchants, inventory management for the plurality of merchants, and a financial health for the plurality of merchants.

13. The non-transitory computer readable storage medium of claim 11, wherein the trained machine learning marketplace is trained using historical data comprising market conditions, a regulatory environment, a competitive landscape, seasonality, geopolitical factors, and supply chain stability.

14. The non-transitory computer readable storage medium of claim 11, wherein the risk for each merchant is based on an industry of the merchant, historical chargebacks/returns involving the merchant, fraudulent activity based on consumer profiles involving the merchant, an average order value for the merchant, and return patterns for the merchant.

15. The non-transitory computer readable storage medium of claim 11, wherein each of the plurality of merchants is associated with a reserve account for that merchant.

16. The non-transitory computer readable storage medium of claim 15, wherein the reserve account for each merchant is funded by the associated merchant.

17. The non-transitory computer readable storage medium of claim 11, wherein the virtual transaction account comprises an account that is issued by a financial institution for ledgering of customer funds.

18. The non-transitory computer readable storage medium of claim 11, further including instructions stored thereon, which when read and executed by the one or more computer processors, cause the one or more computer processors to perform steps comprising:
receiving payment for a good or service provided by one of the merchants from a customer;
moving a portion of the payment to a merchant account for the merchant;
receiving a request for a refund from the customer;
refunding the payment to the customer from a merchant operator virtual transaction account; and
moving funds for the payment from the merchant virtual transaction account to the merchant operator virtual transaction account.

19. The non-transitory computer readable storage medium of claim 18, further including instructions stored thereon, which when read and executed by the one or more computer processors, cause the one or more computer processors to perform steps comprising:
moving funds from the reserve account in response to the merchant virtual transaction account having insufficient funds.

20. The non-transitory computer readable storage medium of claim 11, further including instructions stored thereon, which when read and executed by the one or more computer processors, cause the one or more computer processors to perform steps comprising:
re-assessing the risk; and
adjusting the funding in response to the re-assessing.
